(19) United States
(12) Patent Application Publication
(10) Pub. No.: US 2003/0230623 A1
(43) Pub. Date: Dec. 18, 2003

(54) Means for brazing palladium alloy elements intended for hydrogen purifier

(76) Inventor: Joseph Edward Fleckenstein, Reading, PA (US)

Correspondence Address: Joseph E. Fleckenstein, Fleckenstein Engineering Inc, 156 Castleton Drive, Reading, PA, 19607, US

(21) Appl. No.: 10/171,673

(22) Filed: Jun. 17, 2002

(51) Int. Cl. B23K 37/00

(52) U.S. Cl. 228/47.1

(57) ABSTRACT

A means that permits the simultaneous brazing of coiled palladium alloy elements of a hydrogen purifier to a common base that allows the serial interconnecting of subassemblies in an axial orientation.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO MICROFILCHE APPENDIX

Not Applicable

### BACKGROUND OF THE INVENTION

Hydrogen purifiers that use palladium alloy elements are devices for producing hydrogen at very high levels of purity. The hydrogen gas produced by these types of purifiers is commonly termed ‘ultra pure hydrogen’, and the hydrogen gas is commonly used for basic research as well as in the day-to-day manufacture of integrated circuit chips. Hydrogen purifiers achieve these high levels of purity by using a unique property of the alloys of palladium that allows only pure hydrogen gas to pass through the alloy. This unique property of the metal palladium was first recognized in Snelling U.S. Pat. No. 1,174,631. Hunter U.S. Pat. No. 2,773,561 later introduced improvements by alloying the palladium metal with silver to allow significant reductions in the fabrication costs.

Much of the art related to hydrogen purifiers that use palladium alloys recognizes the need to conserve the amount of palladium metal used in the hydrogen purifier. This is in large part due to the very high cost of the palladium metal. For this reason, most of the palladium alloy elements used in hydrogen purifiers are of a very thin cross section. A typical element thickness would be in the proximity of 0.001 inch to 0.005 inch. In practice, it has been found difficult to consistently manufacture elements of a thickness less 0.001 inch. In addition, elements less than 0.001 inch in thickness would become prone to rupture due to the weak physical strength of components of these dimensions. On the other hand, a thickness above approximately 0.005 inch would require unnecessarily large and expensive quantities of the palladium alloy. Thus, the thickness chosen for a particular design would of necessity be a compromise of several considerations.

The configuration of elements used in a hydrogen purifier, much like the thickness, is dictated by a combination of conditions. In any event, there will generally be a need to obtain the maximum surface area for a given amount of palladium alloy. This need for maximum surface area for a given quantity of palladium metal is combined with a need to contain the purifier elements within a relatively small envelope. This combination of requirements is addressed in a number of patents and is particularly well elucidated in Emerson U.S. Pat. No. 3,279,154. The existing art indicates palladium alloy elements used in hydrogen purifiers are commonly in the sheet or tubular forms. Mostly, the tubular form is used as is typically illustrated in Hunter U.S. Pat. No. 2,961,062 and Hammond U.S. Pat. No. 3,761,382. In the designs of hydrogen purifiers that use tubular elements, the impure hydrogen gas is sometimes introduced to the interior of the tubular elements as in Green U.S. Pat. No. 2,911,057 and Bunn U.S. Pat. No. 4,003,725. Nevertheless, other designs of hydrogen purifiers are arranged to have the impure hydrogen gas introduced to the exterior of tubular elements as in King U.S. Pat. No. 2,536,610 and Hunter U.S. Pat. No. 2,961,062.

The configurations of tubular elements used in hydrogen purifiers generally are in one of two popular forms. These two common configurations can best be described as “straight” and “coiled.” Takashi U.S. Pat. No. 3,368,329 and Ehlers U.S. Pat. No. 3,251,173 exhibit examples of configurations that use the straight forms, whereas Emerson U.S. Pat. No. 3,279,154 and Rubin U.S. Pat. No. 3,274,754 utilize elements in the coiled arrangement.

The relatively thin palladium alloy elements of the hydrogen purifier are hermetically joined to pressure-containing, metallic components that must be of larger dimensions, substantially greater strength and lower cost material. This requirement of the construction presents unique problems in the brazing process that is commonly used to join the two types of components. In many configurations of hydrogen purifiers, the palladium alloy elements are individually brazed to the component that secures the element. This method is especially time consuming and tedious. In some designs, hand-held torches are used to braze the individual components. This is a procedure that is prone to creating hot spots in the relatively thin palladium alloy elements and one which often results in local degradation of the palladium alloy elements. This degradation, in turn, results in fissures and leaks that may develop after the hydrogen purifier is placed into service. Failures that occur after the unit has been placed into service can be especially inconvenient and costly. Furthermore, hand brazing requires the use of a flux that becomes a troublesome source of contamination in a device that is intended to produce gas at a very high level of purity. While there are some techniques that permit simultaneous brazing of all of the elements in the straight configuration, there is no like brazing method for elements in the coiled form. Yet, elements in the coiled form are desirable because the shape of the coiled elements allows nesting of the coils one within the other and a resulting compact envelope.

For several reasons, hydrogen purifiers are very expensive. The high cost of the palladium metal is one of the reasons. Another reason for the high cost is the large variation in required purifying capacities. In part for this reason, hydrogen purifiers are commonly manufactured only in response to specific sales order. Production line techniques have been deemed unsuitable as this method would require the fabrication and storage of an unwieldy variety of sizes of hydrogen purifiers.

### SUMMARY OF THE INVENTION

This invention pertains to a means that facilitates the simultaneous brazing of palladium alloy elements arranged in the coiled configuration and which are intended for use in hydrogen purifiers. The invention uses relatively small components that, because of the size and innovative construction, permits the application of a heat source in a manner that results in the simultaneous brazing of all of the palladium alloy elements of a subassembly. Brazing may be accomplished by induction heating in an inert atmosphere or vacuum furnace brazing thereby avoiding the inconsistent results obtained with hand held torches. The use of fluxes is alleviated and this step, alone, eliminates the impurities that would be introduced by the presence of the flux. As a result of the improvements afforded by the invention, the brazing process used to fasten the palladium alloy elements becomes less costly than known techniqujes and, at the some time, more reliable.

The improvements provided by this invention are obtained primarily by the introduction of a novel component, termed herein an ‘element base’, which component directs purified hydrogen gas inward to an associated tube. The associated tube is aligned axially and thus permits multiple joining of subassemblies containing the palladium alloy subassemblies. The invention allows use of coiled elements in a nested assembly with the result that the completed hydrogen purifier envelope is of a compact size and one that permits the serial interconnecting of like assemblies in an axial orientation. The principals used in the invention allow hydrogen purifier subassemblies to be manufactured in a production line method and conveniently stored until required for assembly to meet sales order requirements. The resulting costs of manufacturing are substantially reduced, and the associated costs of large inventories are avoided.

### BRIEF DESCRIPTION OF DRAWINGS

FIG. 1—Typical tubular palladium alloy element in the straight configuration

FIG. 2—Typical tubular palladium element in the coiled configuration

FIG. 3—Typical element base for receiving palladium elements

FIG. 4—Typical UPH tube

FIG. 5—Typical UPH tube and base subassembly

FIG. 6—Typical UPH tube and base subassembly with fittings attached

FIG. 7—Assembly consisting of palladium alloy elements secured to UPH and base subassembly

FIG. 8—Two assemblies grouped together

### DESCRIPTION OF A PREFERRED EMBODIMENT

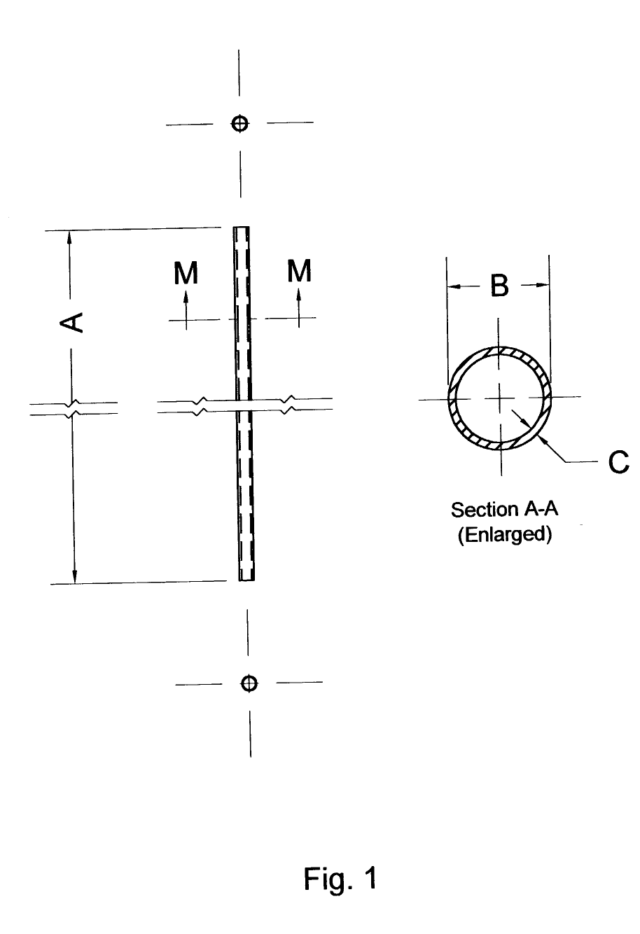

FIG. 1 describes a typical palladium alloy element of the tubular shape that is used in hydrogen purifiers. The element is of length ‘A’, outside diameter ‘B’ and wall thickness ‘C.’ Typical dimensions of a single element are: length A equal to 12 feet; outside diameter B equal to 0.064 inch, and wall thickness C equal to 0.004 inch.

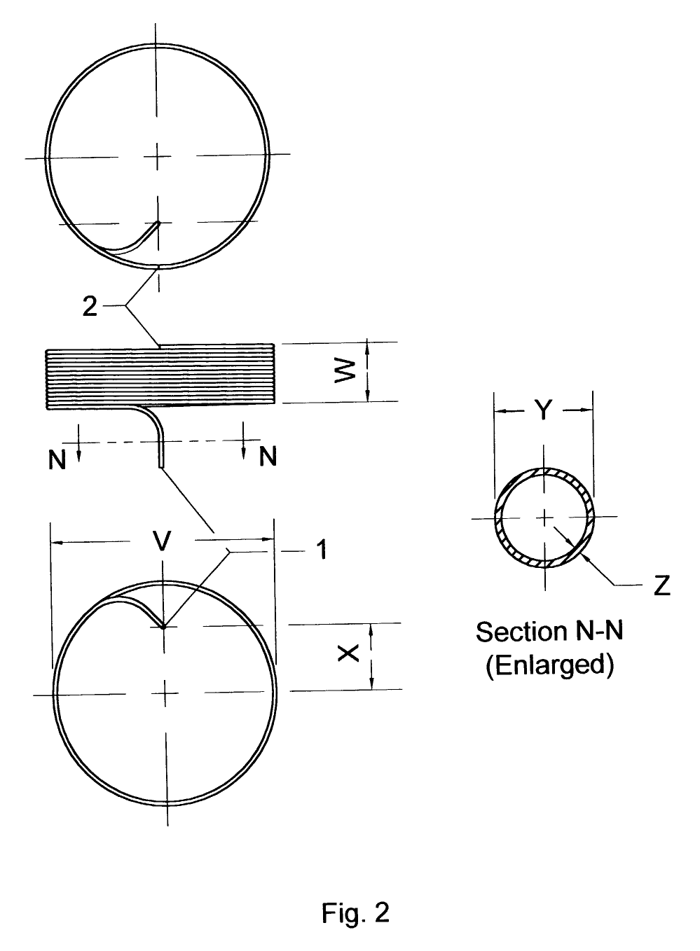

FIG. 2 describes a typical palladium alloy element that has been shaped into the coiled form. The element configuration illustrated in FIG. 2 would be formed by taking an element of the configuration shown in FIG. 1 and coiling it about a cylindrically shaped mandrel to obtain the coiled configuration. The element is formed to outside diameter ‘V’ and the resulting height of the coiled element is ‘W.’ One end 1 of the element is bent toward the center of the element to a dimension ‘X’ from the center of the coil in preparation for brazing. The opposite end 2 of the element is hermetically sealed by means of fuse welding. The outside diameter of the coiled element on the outside of a nest would typically be in the proximity of 3.375 inch. The ‘Y’ dimension of FIG. 2 would be identical to the ‘B’ dimension of FIG. 1 and the ‘Z’ dimension of FIG. 2 would be comparable to the ‘C’ dimension of FIG. 1.

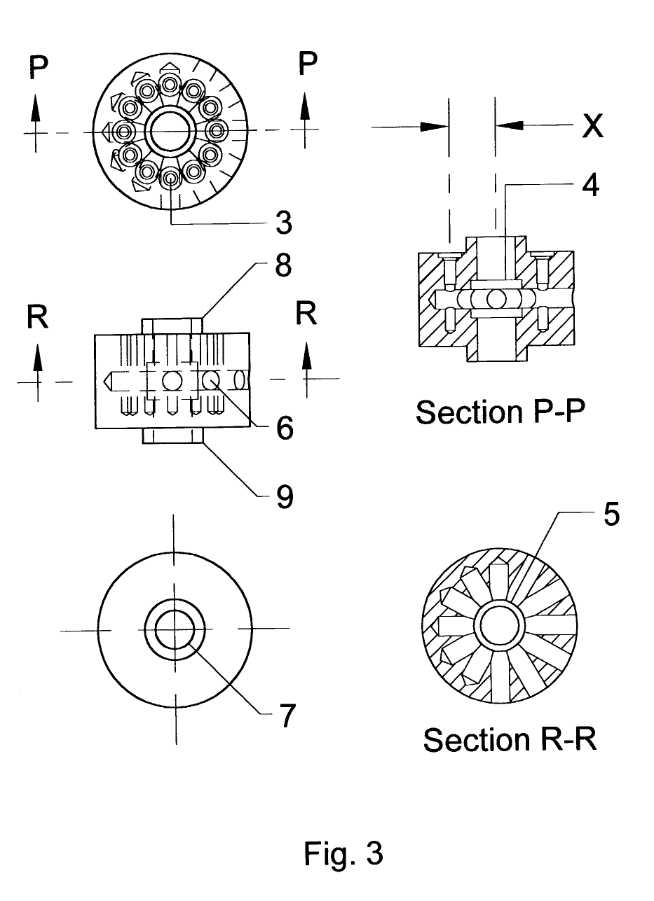

FIG. 3 describes a typical configuration of the unique component that permits simultaneous brazing of all of the elements of a subassembly and which, for the purposes of convenient reference, is termed herein an ‘element base.’ The element base is machined of a metal compatible to palladium. The element base has drilled holes 3 that are provided to accept the palladium alloy elements. The element base has machined into it a cavity that is shown as Item 4 in Section P-P and as Item 5 in Section R-R. Cross-drilled holes 6 connect the internal cavities created by holes 3 with cavity 4. After holes 6 are drilled, they are sealed at the periphery of the element base by either welding or brazing. The element base is also drilled with a hole 7 to accommodate the UPH tube that will be fitted to it. Shoulder 8 and shoulder 9 are provided to allow orbital welding of the element base to the UPH tube.

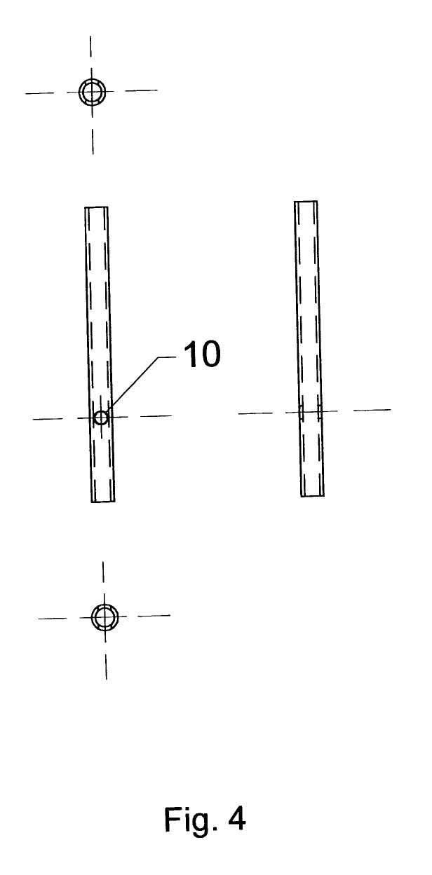

FIG. 4 describes the construction of a typical UPH (ultra pure hydrogen) tube. The UPH tube has a drilled hole 10 that, when placed in service with the element base, will provide a conduit for the hydrogen gas to flow from outside the periphery of the tube to the interior passages of the tube.

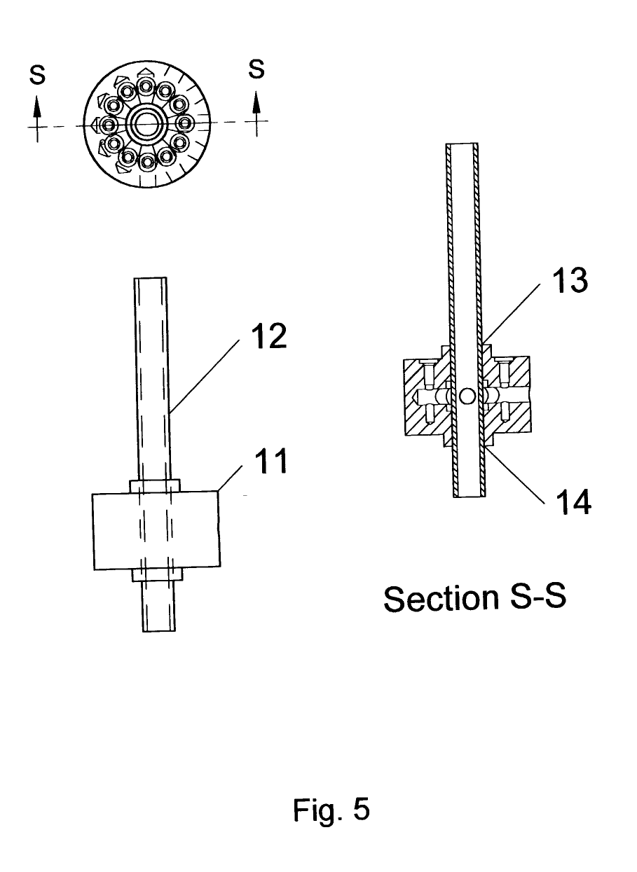

FIG. 5 describes a subassembly that consists of an element base 11 fitted with an UPH tube 12. The UPH tube is positioned so that the hole in the UPH tube aligns with the internal cavity in the element base as illustrated in Section S-S of FIG. 5. When aligned axially in the proper position, the UPH tube is orbital welded to the element base at location 13 and location 14. When placed into service, the purified hydrogen gas gathered within the palladium alloy elements will flow into the drilled holes 3 in the element base to the cross drilled holes 6 and thence to the internal cavity 4. From cavity 4, the purified hydrogen gas will flow through hole 10 in the UPH tube to the interior of the UPH tube where in will be available for delivery to the user.

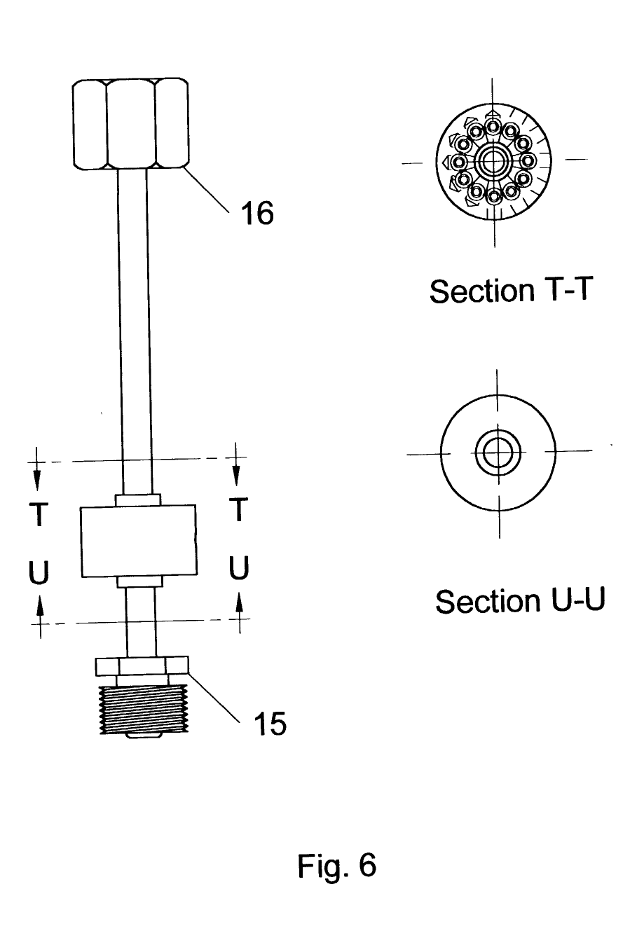

FIG. 6 describes a completed subassembly consisting of the aforementioned element base and UPH tube with end fittings attached to the ends of the UPH tube. Hydrogen gas gathered within the subassembly will flow through VCR fitting 15 to the user. If the subassembly of FIG. 6 is to connect to other like assemblies, fitting 16 will be used to complete that connection. If the assembly of FIG. 6 were to be used alone, fitting 16 would be fitted with a cap to prevent the escape of hydrogen gas.

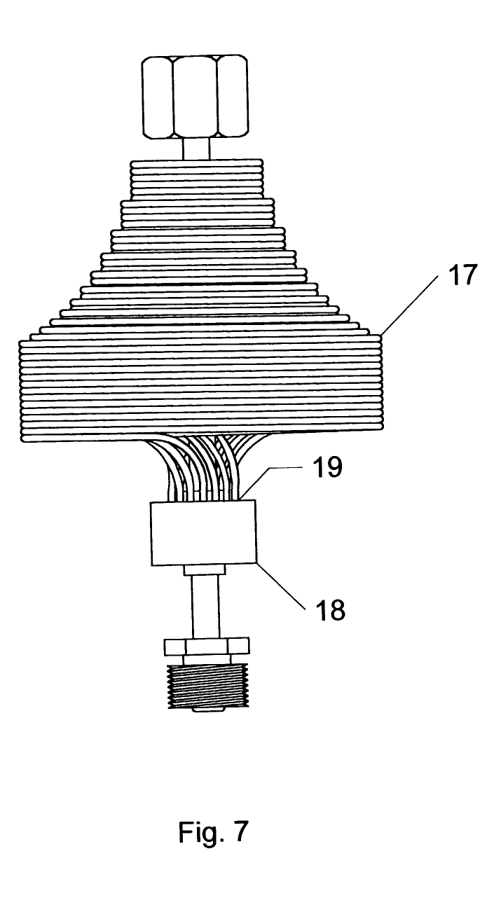

FIG. 7 illustrates a completed assembly that has the palladium alloy elements 17 brazed in place. To join the palladium alloy elements 17 to the element base 18, an assembler would first insert the ends of the palladium alloy elements 17 into holes 3 in the element base 18 at locations 19. Then the elements are brazed to the element base by applying heat in a manner that simultaneously brazes all of the elements to the element base 18. The temperature of the element base 18 may be raised sufficiently high to permit brazing by the application of heat by any of several methods. Prospective, preferred methods of brazing include induction heating in an inert atmosphere or furnace vacuum brazing. Nevertheless, alternate brazing means may be used.

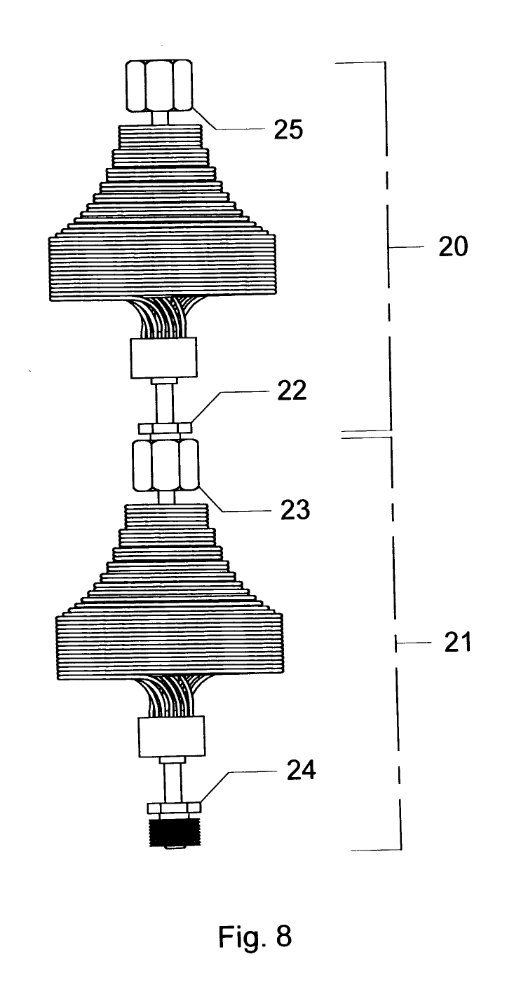

FIG. 8 describes a typical assembly that consists of two of the subassemblies described the FIG. 7. The assembly of FIG. 8 consists of an upper subassembly 20 and a lower subassembly 21. The two subassemblies are connected by means of fitting 22 of the upper subassembly and fitting 23 of the lower subassembly. When placed in service, purified hydrogen gas is made available to the user at fitting 24. If the hydrogen purifier is to use only the two subassemblies of FIG. 8, then fitting 25 is capped. If upper subassembly 20 were to connect to another subassembly, then fitting 25 would be used to connect to a matching fitting of that assembly. Obviously, any number of subassemblies could be connected in series to match any reasonably desired purifying capacity.

I claim:

1. A means to accept a multitude of palladium alloy elements of a hydrogen purifier that permits simultaneous brazing of the palladium alloy elements and which means also allows an axial interconnecting of two or more subassemblies of palladium alloy elements arranged in a coiled configuration.

2. A means intended to accept a multitude of palladium alloy elements of a hydrogen purifier which means directs purified hydrogen gas to interior passages and thence to the interior of a tube which tube is arranged to allow the axial interconnecting of subassemblies and which means also permits the simultaneous brazing of the palladium alloy elements arranged in a coiled configuration.

3. A means intended to accept a multitude of palladium alloy elements of a hydrogen purifier which means directs purified hydrogen gas to interior passages and thence to the interior of a tube which tube is arranged to allow axial interconnecting of a multitude of assemblies and which means also permits simultaneous brazing of the palladium alloy elements, said means consisting of:
a. a metallic base arranged to accept a multitude of palladium alloy elements and which base is arranged to accept a tube and which metallic base has interior cavities arranged to direct gathered purified hydrogen gas to the interior of said tube,
b. a tube that is fitted in said metallic base and which tube is equipped with an opening that aligns with a cavity in said metallic base so as to permit the flow of gathered purified hydrogen gas from cavities within the metallic base to the interior of the tube, which tube has fittings to readily accommodate interconnecting with like tubes of like assemblies.

4. A means intended to accept a multitude of palladium alloy elements of a hydrogen purifier which means directs purified hydrogen gas to interior passages and thence to the interior of a tube which tube is arranged to allow axial interconnecting of a multitude of assemblies and which means also permits simultaneous brazing of the palladium alloy elements arranged in a coiled configuration, said means consisting of:
a. a metallic base arranged to accept a multitude of palladium alloy elements and which base is arranged to accept a tube and which metallic base has interior cavities arranged to direct gathered purified hydrogen gas to the interior of said tube,
b. a tube that is fitted in said metallic base and which tube is equipped with an opening that aligns with a cavity in said metallic base so as to permit the flow of gathered purified hydrogen gas from cavities within the metallic base to the interior of the tube and which tube is positioned to readily accommodate interconnecting with like tubes of like assemblies in an axial orientation.
